(19) United States
(12) Patent Application Publication
(10) Pub. No.: US 2016/0056754 A1
(43) Pub. Date: Feb. 25, 2016

(54) SOLAR TRACKING-TYPE PHOTOVOLTAIC POWER GENERATION SYSTEM CONTROL DEVICE AND SOLAR TRACKING-TYPE PHOTOVOLTAIC POWER GENERATION SYSTEM

(71) Applicant: SUMITOMO ELECTRIC INDUSTRIES, LTD., Osaka-shi (JP)

(72) Inventor: Kenichi KITAYAMA, Osaka-shi (JP)

(21) Appl. No.: 14/781,855

(22) PCT Filed: Feb. 13, 2014
(86) PCT No.: PCT/JP2014/053237

§ 371 Date: Oct. 1, 2015

(30) Foreign Application Priority Data
Apr. 3, 2013 (JP) 2013-077564

(51) Int. Cl. H02S 20/32; G01S 3/786

(52) U.S. Cl. CPC H02S 20/32; G01S 3/7861

(57) ABSTRACT

Provided is a solar tracking-type photovoltaic power generation system control device that can suppress a decrease in the amount of power generation, the decrease being due to a retraction control. A solar tracking-type photovoltaic power generation system 1 includes a solar cell 2 and driving means 3 that inclines and rotates the solar cell 2 so that a light-receiving surface 2b of the solar cell 2 tracks the sun. A control device 4 of the solar tracking-type photovoltaic power generation system 1 includes posture detecting means 11 that detects an inclination posture of the solar cell 2, wind-speed measurement means 12 that measures a wind speed, a setting part 13 that sets a first wind-speed threshold value V1 each time in accordance with the inclination posture of the solar cell 2 detected by the posture detecting means 11, and a control part 14 that performs a retraction control in which, in a case where a wind speed value measured by the wind-speed measurement means 12 exceeds the first wind-speed threshold value V1, the solar cell 2 is laid down by the driving means 3 and is positioned in a retraction posture.

### TECHNICAL FIELD

The present invention relates to a solar tracking-type photovoltaic power generation system control device and a solar tracking-type photovoltaic power generation system.

### BACKGROUND ART

A known photovoltaic power generation system that generates electric power using sunlight is a solar tracking-type photovoltaic power generation system in which a solar cell is moved so that a light-receiving surface of the solar cell tracks the sun in order to improve the amount of power generation (refer to PTL 1).

FIGS. 9A and 9B are side views illustrating an existing solar tracking-type photovoltaic power generation system.

In this solar tracking-type photovoltaic power generation system, a solar cell 103 is attached to an upper end of a support 102, which is arranged perpendicular to a ground surface, with a swivel 105 therebetween in a horizontally rotatable manner. The solar cell 103 is rotatably inclined between a vertical posture illustrated in FIG. 9A and a horizontal posture illustrated in FIG. 9B by extending and contracting a cylinder 104 attached to the swivel 105. Thus, in this solar tracking-type photovoltaic power generation system, a light-receiving surface 103a of the solar cell 103 can be constantly made to face the sun by inclining the solar cell 103 by extending and contracting the cylinder 104 while rotating the swivel 105.

When the sun is located at a position near the horizon in the morning and evening hours, the solar cell 103 is positioned in the vertical posture so that the light-receiving surface 103a faces the sun. Therefore, the solar cell 103 directly receives a cross wind shown by the arrow a′ in FIG. 9A. When the solar cell 103 receives such a cross wind, there may be a problem in that, for example, the support 102 falls over due to the power of the wind and becomes damaged.

To address this problem, a retraction control is usually performed in existing solar tracking-type photovoltaic power generation systems. Specifically, for example, an anemometer (not shown in the figures) is provided on an upper end of the solar cell 103. When the anemometer measures a wind-speed threshold value for a predetermined period of time, the solar cell 103 is retracted so as to be positioned in the horizontal posture, in which the solar cell 103 is not easily affected by a cross wind. The wind-speed threshold value is determined by considering the worst case scenario, specifically, by calculating a wind speed value at which the support 102 etc. can withstand when the solar cell 103 receives a facing cross wind in the vertical posture.

### CITATION LIST

### Patent Literature

### PTL 1: Japanese Unexamined Patent Application Publication No. 2002-151722

### SUMMARY OF INVENTION

### Technical Problem

In the existing solar tracking-type photovoltaic power generation system, the wind-speed threshold value used for the retraction control is equally applied regardless of the season and the time. Therefore, for example, at noon in the summer solstice in Tokyo, the solar cell 103 is positioned in a posture tilted at an angle of about 15 degrees with respect to the horizontal posture, that is, in a posture in which the solar cell 103 can sufficiently withstand a cross wind. However, even in this case, when the anemometer measures a wind-speed threshold value when the solar cell 103 is in the vertical posture, the solar cell 103 is retracted.

As described above, in the existing solar tracking-type photovoltaic power generation system, even when the solar cell 103 is positioned in a posture in which the solar cell 103 can withstand a cross wind, the solar cell 103 may be retracted from a state in which the light-receiving surface 103a faces sunlight. Therefore, a problem of a decrease in the amount of power generation occurs. In particular, in the case of using a concentrating solar cell that generates electric power by concentrating sunlight, the amount of power generation becomes zero only due to a deviation of a focal point of light concentration from a power generating element. Therefore, such a change causes an extremely large effect compared with a case of a solar cell other than such a concentrating solar cell.

The present invention has been made in view of the problem described above. An object of the present invention is to suppress a decrease in the amount of power generation, the decrease being due to a retraction control, without impairing safety.

### Solution to Problem

(1) The present invention provides a solar tracking-type photovoltaic power generation system control device including a solar cell and driving means that inclines and rotates the solar cell so that a light-receiving surface of the solar cell tracks the sun. The control device includes posture detecting means that detects an inclination posture of the solar cell, wind-speed measurement means that measures a wind speed, a setting part that sets a first wind-speed threshold value each time in accordance with the inclination posture of the solar cell detected by the posture detecting means, and a control part that performs a retraction control in which, in a case where a wind speed value measured by the wind-speed measurement means exceeds the first wind-speed threshold value, the solar cell is laid down by the driving means and is positioned in a retraction posture.

According to the solar tracking-type photovoltaic power generation system control device of the present invention, the first wind-speed threshold value that serves as a standard for causing the solar cell to be positioned in a retraction posture is set each time in accordance with the inclination posture of the solar cell detected by the posture detecting means. Therefore, the first wind-speed threshold value can be set to an appropriate value in accordance with the inclination posture of the solar cell. Accordingly, it is possible to prevent a phenomenon in which, although the solar cell is positioned in an inclination posture in which the solar cell can withstand a wind speed value measured by the wind-speed measurement means, a retraction control is performed from the inclination posture. As a result, the number of times the retraction control is performed can be reduced compared with existing systems, and thus a decrease in the amount of power generation, the decrease being due to the retraction control, can be suppressed.

Herein, the term “solar cell” refers to not only a photovoltaic cell but also a solar cell panel (solar cell module) including a plurality of photovoltaic cells or a solar cell array including a plurality of solar cell panels.

(2) The control part preferably performs a revertive control in which, in a case where, after the retraction control is performed, the wind speed value measured by the wind-speed measurement means is lower than a second wind-speed threshold value for a predetermined period of time, the solar cell is caused to revert to an inclination posture in which the solar cell tracks the sun.

In this case, the solar cell can be caused to automatically revert from a retracted state to an inclination posture in which the solar cell tracks the sun. Therefore, a decrease in the amount of power generation, the decrease being due to the retraction control, can be further suppressed.

The retraction posture is preferably an inclination posture described in (3) or (4) below so that the solar cell can withstand a maximum wind speed that can be expected in the region where the solar cell is installed.

(3) The retraction posture is preferably a posture in which the light-receiving surface of the solar cell is positioned horizontally. In this case, by the retraction control, the solar cell is positioned in the safest retraction posture in which the solar cell can withstand strong winds.
(4) The retraction posture is preferably a posture in which the light-receiving surface of the solar cell is tilted in a rising direction with respect to a horizontal plane. In this case, when the solar cell is retracted, the light-receiving surface of the solar cell is held in a tilted state (for example, in a state of being tilted at an angle of more than 0° and 20° or less with respect to the horizontal plane). Therefore, accumulation of foreign matter such as rainwater and dust on the light-receiving surface of the solar cell can be suppressed. It is also possible to reduce the time necessary for raising the solar cell so as to cause the solar cell to revert to the inclination posture in which the solar cell tracks the sun, as compared with a retraction posture in which the light-receiving surface of the solar cell is positioned horizontally in the state where the solar cell is retracted.
(5) In the retraction control, in a case where the wind speed value measured by the wind-speed measurement means exceeds a third wind-speed threshold value after the solar cell is positioned in the retraction posture, the control part preferably further lays down the solar cell by the driving means until the light-receiving surface of the solar cell is positioned horizontally.

In this case, even when a strong wind blows after the solar cell is positioned in the retraction posture, the solar cell can be positioned in a safer posture.

(6) The solar cell is preferably a concentrating solar cell that generates electric power by concentrating sunlight.

In this case, a significant advantage is achieved. Compared with a non-concentrating solar cell that generates electric power even with scattered light, in the case of a concentrating solar cell that generates electric power only with direct light radiation, when the direct light radiation does not reach a power generating element as a result of retraction control, the amount of power generation becomes zero. Accordingly, it is possible to prevent a phenomenon in which, although the solar cell is positioned in the inclination posture in which the solar cell can withstand a wind speed value measured by the wind-speed measurement means, a retraction control is performed from the inclination posture, and the amount of power generation thereby becomes zero. As a result, a decrease in the amount of power generation, the decrease being due to the retraction control, can be effectively suppressed.

(7) A solar tracking-type photovoltaic power generation system according to another aspect of the present invention includes a solar cell, driving means that inclines and rotates the solar cell so that a light-receiving surface of the solar cell tracks the sun, and the solar tracking-type photovoltaic power generation system control device according to (1) above.
(8) The solar tracking-type photovoltaic power generation system may include a plurality of solar tracking-type photovoltaic power generation devices each including the solar cell and the driving means that form a pair. The control device may include the posture detecting means that is single posture detecting means, the wind-speed measurement means that is single wind-speed measurement means, the setting part that is a single setting part, and the control part that is a single control part, and the single control part may perform the retraction control for the solar cells of the solar tracking-type photovoltaic power generation devices of the pairs. In this case, the retraction control can be performed for all the solar cells of the solar tracking-type photovoltaic power generation devices that form the plurality of pairs by the single control part that uses the single posture detecting means and the single wind-speed measurement means. Accordingly, the structure of the solar tracking-type photovoltaic power generation system can be simplified.

### Advantageous Effects of Invention

According to the present invention, a decrease in the amount of power generation, the decrease being due to a retraction control, can be suppressed.

### BRIEF DESCRIPTION OF DRAWINGS

FIG. 1 is a perspective view illustrating a solar tracking-type photovoltaic power generation system according to a first embodiment of the present invention.

FIG. 2A is a side view illustrating a solar tracking-type photovoltaic power generation system and illustrates a state where a solar cell is positioned in a vertical posture.

FIG. 2B is a side view illustrating a solar tracking-type photovoltaic power generation system and illustrates a state where a solar cell is positioned in a horizontal posture.

FIG. 3 is a block diagram illustrating a structure of a solar tracking-type photovoltaic power generation system.

FIG. 4 is a graph showing a relationship between a wind speed and a wind pressure received by a solar cell from a cross wind in the case where an array angle of the solar cell 2 is changed.

FIG. 5 is a flowchart executed in order to calculate wind speed data.

FIG. 6 is a flowchart of a retraction control executed by a control device.

FIG. 7 is a flowchart of a revertive control executed by a control device.

FIG. 8 is a flowchart of a retraction control executed by a solar tracking-type photovoltaic power generation system control device according to a second embodiment of the present invention.

FIG. 9A is a side view illustrating an existing solar tracking-type photovoltaic power generation system and illustrates a state where a solar cell is positioned in a vertical posture.

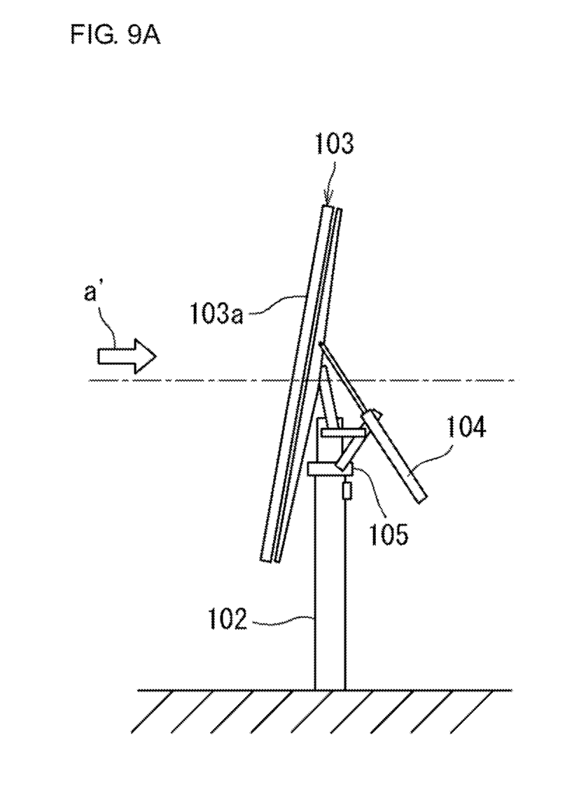

FIG. 9B is a side view illustrating an existing solar tracking-type photovoltaic power generation system and illustrates a state where a solar cell is positioned in a horizontal posture.

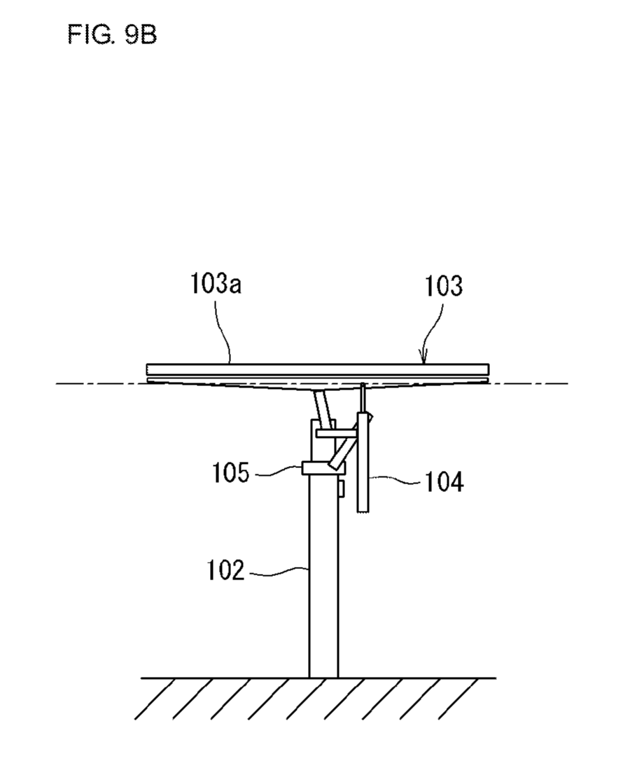

### REFERENCE SIGNS LIST

1 solar tracking-type photovoltaic power generation system
2 solar cell
2a solar cell panel
2b light-receiving surface
3 driving means
3a inclination driving means
3b rotation driving means
4 control device
6 support
7 swivel
8 solar tracking-type photovoltaic power generation device
11 posture detecting means
12 wind-speed measurement means
13 setting part
14 control part
14a first determination part
14b second determination part
14c third determination part
102 support
103 solar cell
103a light-receiving surface
104 cylinder
105 swivel
H horizontal plane

### DESCRIPTION OF EMBODIMENTS

Preferred embodiments of the present invention will now be described with reference to the drawings.

### [Solar Tracking-Type Photovoltaic Power Generation System]

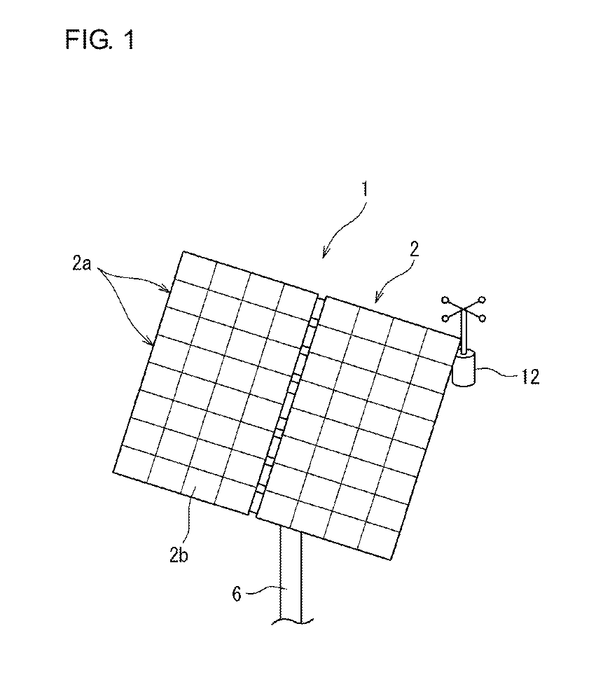

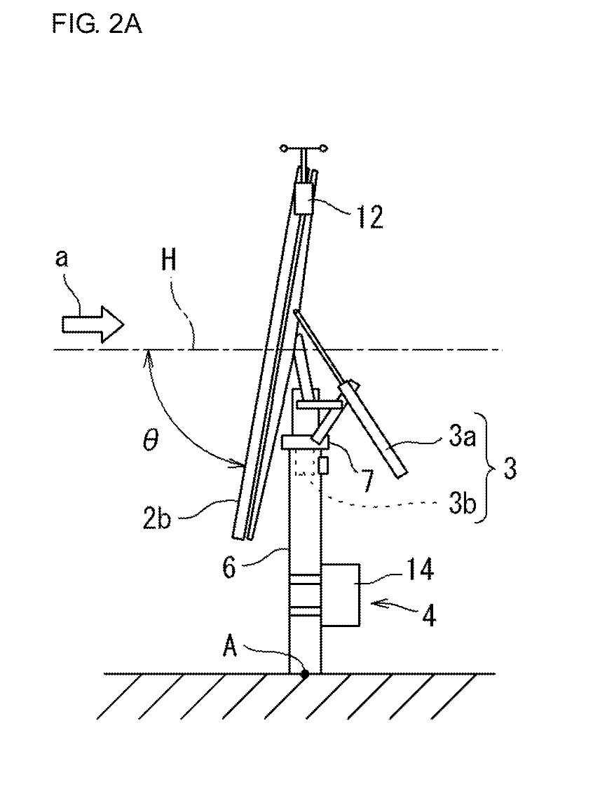

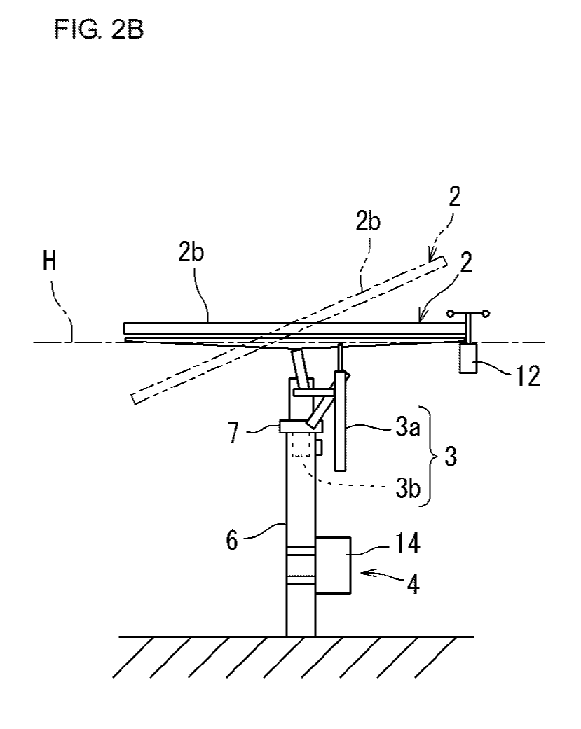

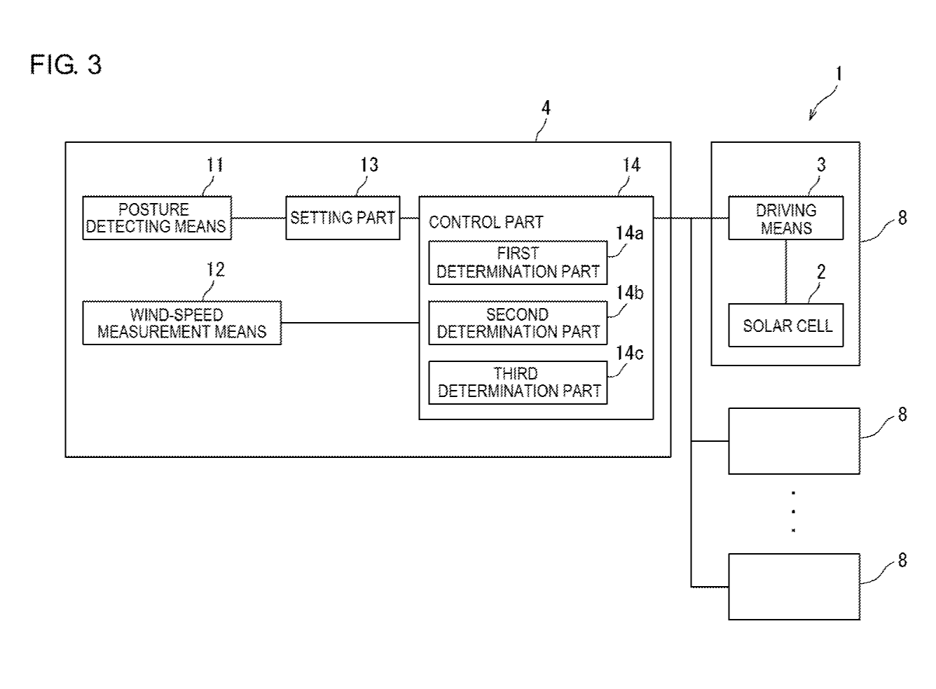

FIG. 1 is a perspective view illustrating a solar tracking-type photovoltaic power generation system 1 according to a first embodiment of the present invention. FIGS. 2A and 2B are side views illustrating the solar tracking-type photovoltaic power generation system 1. FIG. 3 is a block diagram illustrating a structure of the solar tracking-type photovoltaic power generation system 1.

As illustrated in FIG. 3, the solar tracking-type photovoltaic power generation system 1 of the present embodiment is constituted by arranging a plurality of solar tracking-type photovoltaic power generation devices 8, each of which includes a solar cell 2 that generates electric power by using sunlight and driving means 3 that inclines and rotates the solar cell 2 so that a light-receiving surface 2b (refer to FIG. 1) of the solar cell 2 tracks the sun, the solar cell 2 and the driving means 3 forming a pair. The number of the solar tracking-type photovoltaic power generation devices 8 is appropriately determined on a case-by-case basis.

The solar tracking-type photovoltaic power generation system 1 further includes a single control device 4 provided in one of the solar tracking-type photovoltaic power generation devices 8 of any of the plurality of pairs. This control device 4 is configured to perform a retraction (revertive) control described below for the solar cells 2 of all the solar tracking-type photovoltaic power generation devices 8. The solar tracking-type photovoltaic power generation system 1 of the present embodiment includes the single control device 4. Alternatively, the solar tracking-type photovoltaic power generation system 1 may include a plurality of control devices 4 that individually control the plurality of solar tracking-type photovoltaic power generation devices 8.

As illustrated in FIGS. 1, 2A, and 2B, a solar cell 2 is a concentrating solar cell that generates electric power by concentrating sunlight with a lens (not shown in the figures). The solar cell 2 is attached to an upper end of a support 6, which is arranged perpendicular to a ground surface, with a swivel 7 therebetween in a horizontally rotatable manner and in an inclinable manner. The solar cell 2 of the present embodiment is constituted by a solar cell array in which a plurality of solar cell panels 2a each including a plurality of photovoltaic cells (not shown) are connected to one another.

In the present embodiment, a solar cell array forms the solar cell 2. Alternatively, one or a plurality of solar cell panels 2a or one or a plurality of photovoltaic cells may form the solar cell 2. The solar cell 2 may be a non-concentrating solar cell that generates electric power by direct irradiation with sunlight, for example, a silicon solar cell.

The driving means 3 includes inclination driving means 3a that rotatably inclines the solar cell 2 and rotation driving means 3b that rotates the solar cell 2 horizontally. The inclination driving means 3a includes, for example, a hydraulic cylinder. By extending and contracting the hydraulic cylinder, the solar cell 2 can be rotatably inclined between a vertical posture illustrated in FIG. 2A (in this case, array angle θ of solar cell 2=80°) and a horizontal posture illustrated by the solid line in FIG. 2B (array angle θ of solar cell 2=0°). Herein, the term “array angle” refers to a tilt angle (vertical angle) of a solar cell array with respect to a horizontal plane H, as illustrated in FIG. 2A.

The rotation driving means 3b includes, for example, a hydraulic motor and is disposed in the support 6. The rotation driving means 3b is configured to rotate the solar cell 2 horizontally around the axis of the support 6 by rotating the swivel 7. Accordingly, the light-receiving surface 2b of the solar cell 2 can be constantly made to face the sun by inclining the solar cell 2 with the inclination driving means 3a while rotating the solar cell 2 horizontally with the rotation driving means 3b.

A single control device is installed in the system 1 as the control device 4. The single control device 4 controls an inclination posture of the solar cell 2 during a strong wind. This control device 4 will now be described in detail.

### [Control Device]

As illustrated in FIG. 3, a control device 4 includes single posture detecting means 11, single wind-speed measurement means 12, a single setting part 13, and a single control part 14.

The control part 14 is attached to the support 6 (refer to FIG. 2A) and performs a retraction control and a revertive control. In the retraction control, the solar cell 2 is laid down by the driving means 3 and is positioned in a retraction posture. In the revertive control, after the retraction control is performed, the solar cell 2 is caused to revert to an inclination posture in which the light-receiving surface 2b of the solar cell 2 tracks the sun.

The retraction posture is preferably set so that the array angle θ of the solar cell 2 is in a range of 10° to 30°. In the present embodiment, as shown by the chain double-dashed line in FIG. 2B, the array angle θ of the solar cell 2 is set to 20°.

The posture detecting means 11 detects the inclination posture of the solar cell 2 and includes, for example, a tilt sensor attached to the solar cell 2. The tilt sensor senses the array angle θ of the solar cell 2. Alternative to such a tilt sensor, the posture detecting means 11 may calculate the direction and the elevation angle of the sun on the basis of the day, the time, and the latitude and the longitude in the place where the solar cell 2 is installed and may determine the array angle θ of the solar cell 2 corresponding to the calculated elevation angle.

The wind-speed measurement means 12 includes, for example, an anemometer disposed on an upper end of the solar cell 2 and measures a wind speed in the place where the solar cell 2 is installed. This anemometer is rotatably attached to the solar cell 2, and a weight (not shown) is attached to a lower end thereof so that the anemometer maintains a posture perpendicular to the ground surface even when the solar cell 2 is rotatably inclined. Furthermore, the wind-speed measurement means 12 constantly calculates a moving average wind-speed value for a certain period of time (for example, 5 minutes).

The setting part 13 sets each time a first wind-speed threshold value V1, which serves as a standard for performing the retraction control, in accordance with the inclination posture of the solar cell 2 detected by the posture detecting means 11. Specifically, on the basis of a formula (1) below, the setting part 13 first calculates a tolerable wind speed Vd, at which the solar cell 2 needs to be retracted, with respect to a current array angle θ of the solar cell 2.

Vd=√(628.7/sin θ) (1)

This formula (1) is derived by the method described below. As illustrated in FIG. 2A, it is supposed that the support 6 is assumed to be a cantilever beam, an end of which is supported on the ground surface, and that the light-receiving surface 2b of the solar cell 2 receives a cross wind in the direction shown by the arrow a in the figure. In this case, it is supposed that when a moment force exceeding a yield stress of the material of the support 6 acts on a supporting point A on the ground surface that supports the support 6, the support 6 is broken. The moment force varies even when the cross wind has the same wind speed, because the wind-receiving area of the solar cell array varies depending on the array angle θ of the solar cell 2. A drag received by the light-receiving surface 2b of the solar cell 2 from a cross wind with a particular wind speed at a particular array angle θ was calculated by using a general-purpose thermal fluid analysis simulator. In addition, a drag per unit area (hereinafter referred to as “fracture stress”) at which the support 6 is broken was calculated from a section modulus of the support 6, the yield stress of the material, etc. In the present embodiment, the fracture stress was about 658 N/m².

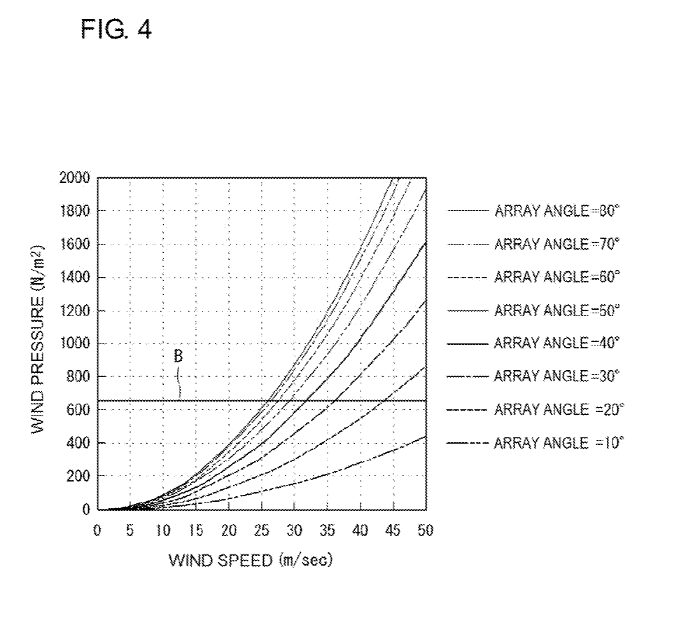

FIG. 4 is a graph showing a relationship between wind speed (m/sec) and wind pressure (N/m²) per unit area received by the light-receiving surface 2b of the solar cell 2 from a cross wind in the case where the array angle θ of the solar cell 2 is changed by every 10°. In FIG. 4, a straight line B shows the fracture stress. FIG. 4 shows that the support 6 is broken on the upper side of an intersection point with the straight line B on a curve of each array angle θ. Accordingly, for example, in the case where the array angle θ is 80°, the support 6 can withstand wind speeds up to about 25 m/s without being damaged. The graph shows that this wind speed at which the support 6 can withstand (hereinafter referred to as “tolerable wind speed”) increases with a decrease in the array angle θ of the solar cell 2, that is, as the solar cell 2 is laid down by a greater degree. It is the formula (1) that is derived to represent the relationship between this tolerable wind speed and the array angle θ.

Next, the setting part 13 calculates the first wind-speed threshold value V1 by using a formula (2) that uses the tolerable wind speed Vd calculated by the formula (1) and a gustiness factor G.

V1=Vd/G (2)

Here, the gustiness factor G is a ratio of a maximum instantaneous wind speed to an average wind speed and is a value determined depending on a region. In Japan, the gustiness factor G is usually determined to 1.5 to 2.0 relative to an average wind speed for 10 minutes. In the case where the value of the gustiness factor G is 2.0 and the average wind speed for 10 minutes is 10 m/s, this gustiness factor G means that a wind with a maximum instantaneous wind speed of 20 m/s, which is double the average wind speed, may blow.

In the present embodiment, the gustiness factor G relative to an average wind speed for 5 minutes is set to 3.0 in order to ensure the security. For example, in the case where the array angle θ of the solar cell 2 is 80°, the tolerable wind speed is 25 m/s as described above. Accordingly, the first wind-speed threshold value V1 is set to 8.6 m/s on the basis of the formula (2) above. In this manner, the first wind-speed threshold value V1 of the present embodiment is set to a value smaller than the tolerable wind speed Vd in consideration of a case where a wind with the maximum instantaneous wind speed blows.

The setting part 13 may set the first wind-speed threshold value V1 without calculating the value V1 as described above. For example, the setting part 13 may include a table in which first wind-speed threshold values V1 that correspond to a plurality of wind speed values are determined in advance. The setting part 13 may set the first wind-speed threshold value V1 with reference to the table and a current wind speed value.

The control part 14 includes a first determination part 14a, a second determination part 14b, and a third determination part 14c.

The first determination part 14a determines whether or not the wind speed value measured by the wind-speed measurement means 12 exceeds the first wind-speed threshold value V1. Specifically, the first determination part 14a determines whether or not the moving average wind-speed value calculated by the wind-speed measurement means 12 exceeds the first wind-speed threshold value V1.

In the case where the result determined by the first determination part 14a is positive, the control part 14 drives and controls the driving means 3 so that the wind speed value measured by the wind-speed measurement means 12 becomes lower than the first wind-speed threshold values V1 calculated by the setting part 13, thus laying down the solar cell 2. In the present embodiment, the control part 14 drives and controls the driving means 3 so that the solar cell 2 is positioned in the retraction posture shown by the chain double-dashed line in FIG. 2B.

The second determination part 14b determines whether or not the wind speed value measured by the wind-speed measurement means 12 is lower than a second wind-speed threshold value V2 for a predetermined period of time Ta and determines a duration time thereof. Specifically, the second determination part 14b determines whether or not the moving average wind-speed value calculated by the wind-speed measurement means 12 is lower than the second wind-speed threshold value V2 and whether or not this state continues for the predetermined period of time Ta. That is, the second determination part 14b determines how many minutes (Ta) a wind speed lower than the predetermined value (V2) continues, the time Ta and the value V2 serving as values at which a storm is considered to have passed. The second wind-speed threshold value V2 and the predetermined period of time Ta are numerical values that significantly depend on regional characteristics. For example, in the case of a typhoon, the strength of the wind suddenly changes, for example, a strong wind continues, a wind temporarily dies down, and a next strong wind then comes. Therefore, it is necessary to determine the second wind-speed threshold value V2 and the predetermined period of time Ta on the basis of a sufficient examination of previous data.

In the case where, after the retraction control is performed, the result determined by the second determination part 14b becomes positive, the control part 14 drives and controls the driving means 3 so that the solar cell 2 is positioned in the inclination posture in which the light-receiving surface 2b of the solar cell 2 tracks the sun.

The third determination part 14c determines whether or not the wind speed value measured by the wind-speed measurement means 12 exceeds a third wind-speed threshold value V3. Specifically, the third determination part 14c determines whether or not an instantaneous wind speed value measured by the wind-speed measurement means 12 exceeds the third wind-speed threshold value V3.

The third wind-speed threshold value V3 is a fixed value serving as a standard for performing the retraction control in which the solar cell 2 is laid down to the horizontal posture when the solar cell 2 is positioned in the retraction posture. The third wind-speed threshold value V3 is memorized in the control part 14 in advance. As a matter of course, the third wind-speed threshold value V3 is less than a value determined by calculating, on the basis of the formula (1), the tolerable wind speed Vd at which the solar cell 2 positioned in the retraction posture (in this case, array angle θ of solar cell 2=20°) needs to be further retracted. In addition, it is safer to memorize a safe third wind-speed threshold value V3 in consideration of, for example, a stress applied to the support 6.

In the case where, after the solar cell 2 is retracted to the retraction posture, the result determined by the third determination part 14c becomes positive, the control part 14 drives and controls the driving means 3 so that the solar cell 2 is further laid down from the retraction posture shown by the chain double-dashed line in FIG. 2B and positioned in the horizontal posture in which the light-receiving surface 2b of the solar cell 2 is positioned horizontally, as shown by the solid line in FIG. 21.

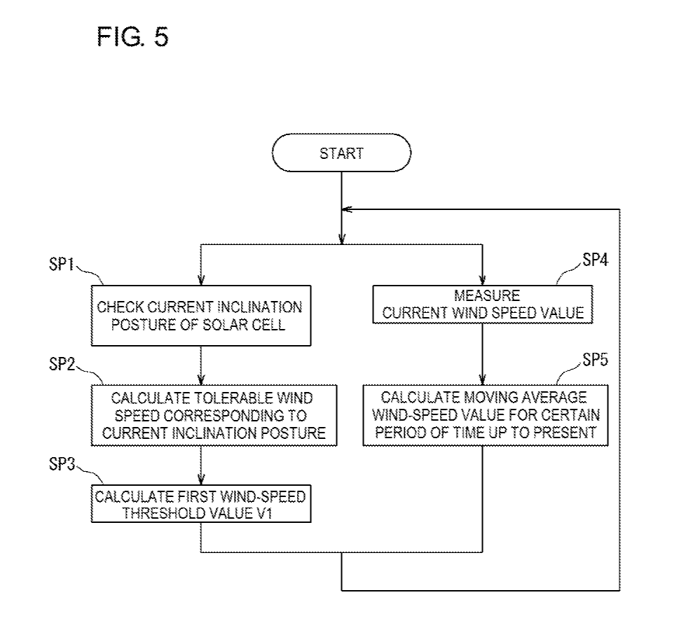

FIG. 5 is a flowchart executed in order to calculate wind speed data (such as the first wind-speed threshold value and the moving average wind-speed value) which are referred to in a retraction control and a revertive control described below. In this flowchart shown in FIG. 5, first, a current inclination posture of the solar cell 2, that is, the array angle θ of the solar cell 2 is checked by the posture detecting means 11 (step SP1). Subsequently, the setting part 13 calculates the tolerable wind speed Vd corresponding to the current inclination posture using the formula (1) (step SP2) and then calculates the first wind-speed threshold value V1 using the formula (2) (step SP3).

In addition, in parallel to the steps SP1 to SP3, a current wind speed value is measured by the wind-speed measurement means 12 (step SP4), and a moving average wind-speed value for a certain period of time up to the present (in this case, five minutes) is calculated by the wind-speed measurement means 12 (step SP5).

In order to calculate the first wind-speed threshold value V1 and the moving average wind-speed value at predetermined intervals (for example, one second), the steps SP1 to SP5 are executed repeatedly in parallel to the retraction control or the revertive control while these controls are performed.

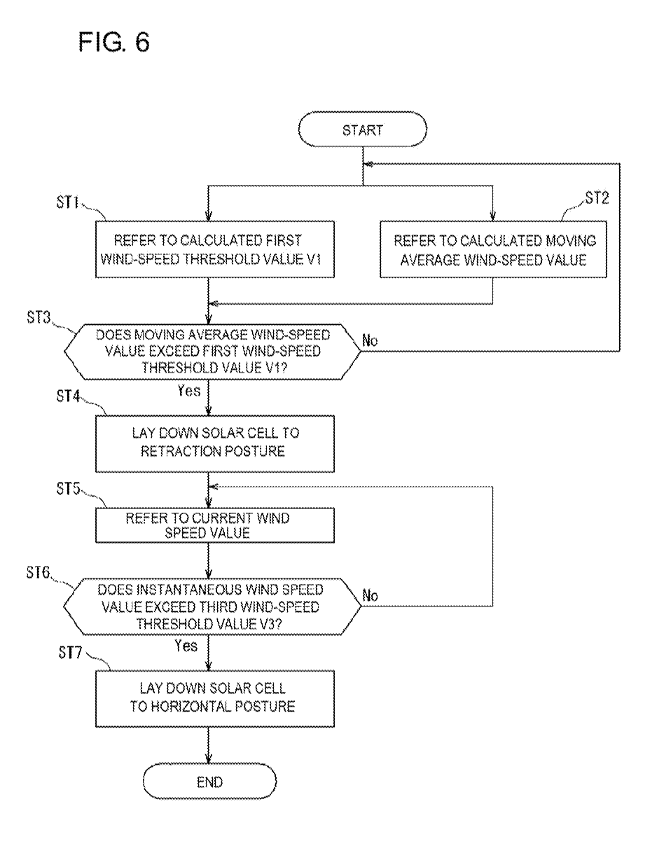

FIG. 6 is a flowchart of a retraction control executed by the control device 4. The retraction control will now be described with reference to this figure.

First, the control part 14 refers to the current first wind-speed threshold value V1 calculated in the step SP3 in FIG. 5 (step ST1). In parallel to the step ST1, the control part 14 refers to the current moving average wind-speed value calculated in the step SP5 in FIG. 5 (step ST2).

Next, the control part 14 determines whether or not the moving average wind-speed value exceeds the first wind-speed threshold value V1 by the first determination part 14a (step ST3). In the case where the result determined by the first determination part 14a is positive, that is, in the case where the moving average wind-speed value exceeds the first wind-speed threshold value V1, the control part 14 lays down the solar cell 2 to a retraction posture (in this case, array angle of solar cell 2=20°) by the driving means 3 (step ST4). In the step ST3, in the case where the result determined by the first determination part 14a is negative, that is, in the case where the moving average wind-speed value does not exceed the first wind-speed threshold value V1, the process is returned to the step ST1 and step ST2, and the control part 14 again refers to the current first wind-speed threshold value V1 and the current moving average wind-speed value.

After the solar cell 2 is positioned in the retraction posture in the step ST4, the control part 14 refers to the current wind speed value measured in the step SP4 in FIG. 5 (step ST5). Subsequently, the control part 14 determines whether or not the current instantaneous wind speed value exceeds the third wind-speed threshold value V3 by the third determination part 14c (step ST6). In the case where the result determined by the third determination part 14c is positive, that is, in the case where the current instantaneous wind speed value exceeds the third wind-speed threshold value V3, the control part 14 further lay down the solar cell 2 from the retraction posture to a horizontal posture (array angle θ of solar cell 2=0°) by the driving means 3 (step ST7).

In the step ST6, in the case where the result determined by the third determination part 14c is negative, that is, in the case where the instantaneous wind speed value does not exceed the third wind-speed threshold value V3, the process is returned to the step ST5, and the control part 14 again refers to the current wind speed value measured in the step SP4 in FIG. 5.

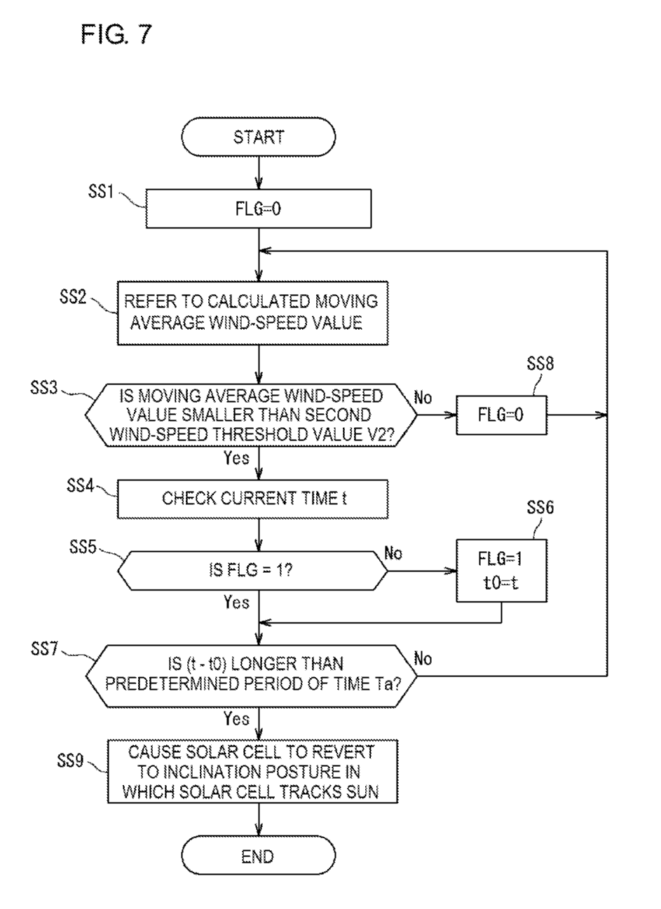

FIG. 7 is a flowchart of a revertive control executed after the control device 4 performs the retraction control described above. The revertive control will now be described with reference to this figure.

First, the control part 14 sets a flag FLG used in this revertive control to “0” (step SS1). Regarding the second wind-speed threshold value V2 and the duration time (predetermined period of time Ta), numerical values corresponding to values at which a storm is considered to die down are respectively determined in advance in consideration of the environment where the system 1 is installed.

Next, the control part 14 refers to the moving average wind-speed value for a certain period of time up to the present (in this case, five minutes) calculated in the step SP5 in FIG. 5 (step SS2).

Next, the control part 14 determines whether or not the moving average wind-speed value is smaller than the second wind-speed threshold value V2 by the second determination part 14b (step SS3). In the case where the determination result is positive, that is, in the case where the moving average wind-speed value is smaller than the second wind-speed threshold value V2, the control part 14 checks a current time t (step SS4) and then checks whether the flag FLG is “1” or not (step SS5). Since the flag FLG is set to “0” immediately after the start of the control, the control part 14 sets the flag FLG to “1” and sets the current time t to a starting time to (step SS6). The process is transferred to a step SS7.

In the step SS7, the control part 14 determines whether or not an elapsed time (t−t0) from the starting time t0 to the current time t is longer than the predetermined period of time Ta by the second determination part 14b. Since the elapsed time (t−t0) immediately after the start of the control is shorter than the predetermined period of time Ta, the process is returned to the step SS2, and the step SS2 to the step SS7 are repeatedly performed until the elapsed time (t−t0) reaches the predetermined period of time Ta. During this time, in the case where the moving average wind-speed value exceeds the second wind-speed threshold value V2 in the step SS3, the control part 14 sets the flag FLG to “0” (step SS8), and the process is returned to the step SS2.

On the other hand, in the case where the elapsed time (t−t0) becomes longer than the predetermined period of time Ta while the moving average wind-speed value remains smaller than the second wind-speed threshold value V2, that is, in the case where the second determination part 14b determines that the elapsed time (t−t0) becomes longer than the predetermined period of time Ta in the step SS7, the control part 14 reverts, by the driving means 3, the solar cell 2 from the retraction posture or the like to an inclination posture in which the solar cell 2 tracks the sun (step SS9).

As described above, according to the solar tracking-type photovoltaic power generation system 1 and the control device 4 of the system according to the present embodiment, the first wind-speed threshold value V1, which serves as a standard for causing the solar cell 2 to be positioned in a retraction posture, is calculated each time in accordance with the inclination posture of the solar cell 2 detected by the posture detecting means 11. Therefore, the first wind-speed threshold value V1 can be set to an appropriate value in accordance with the inclination posture of the solar cell 2. Accordingly, it is possible to prevent a phenomenon in which, although the solar cell 2 is positioned in an inclination posture in which the solar cell 2 can withstand a wind speed value measured by the wind-speed measurement means 12, a retraction control is performed from the inclination posture. As a result, the number of times the retraction control is performed can be reduced compared with existing systems, and thus a decrease in the amount of power generation, the decrease being due to the retraction control, can be suppressed.

In particular, in the case where the solar cell 2 is a concentrating solar cell that generates electric power by concentrating sunlight, when the posture of the solar cell 2 deviates from an inclination posture in which the solar cell 2 tracks the sun, the solar cell 2 cannot concentrate sunlight and the amount of power generation becomes zero. Therefore, a decrease in the amount of power generation, the decrease being due to a retraction control, can be effectively suppressed by reducing the number of times the retraction control is performed.

In addition, in the case where, after the retraction control is performed, the wind speed value measured by the wind-speed measurement means 12 is lower than the second wind-speed threshold value V2 for the predetermined period of time Ta, the control part 14 performs a revertive control where the solar cell 2 is caused to revert to an inclination posture in which the solar cell 2 tracks the sun. Accordingly, the solar cell 2 can be caused to automatically revert from a retracted state to the inclination posture in which the solar cell 2 tracks the sun. As a result, a decrease in the amount of power generation, the decrease being due to the retraction control, can be further suppressed.

Furthermore, in the case where the retraction posture of the solar cell 2 is a posture in which the light-receiving surface 2b of the solar cell 2 is tilted in a rising direction with respect to the horizontal plane H, the light-receiving surface 2b is held in a tilted state in this retraction posture. Therefore, accumulation of foreign matter such as rainwater and dust on the light-receiving surface 2b can be suppressed. It is also possible to reduce the time necessary for raising the solar cell 2 so as to cause the solar cell 2 to revert to the inclination posture in which the solar cell 2 tracks the sun, as compared with a retraction posture in which the light-receiving surface 2b is positioned horizontally.

In the case where, after the solar cell 2 is positioned in the retraction posture, the wind speed value measured by the wind-speed measurement means 12 exceeds the third wind-speed threshold value V3, the solar cell 2 is positioned in a posture in which the light-receiving surface 2b thereof is positioned horizontally. Therefore, the solar cell 2 can be positioned in a safer posture.

Furthermore, the retraction control can be performed for all the solar cells 2 of the solar tracking-type photovoltaic power generation devices 8 that form the plurality of pairs by the single control part 14 that uses the single posture detecting means 11 and the single wind-speed measurement means 12. Accordingly, the structure of the solar tracking-type photovoltaic power generation system 1 can be simplified.

### Second Embodiment

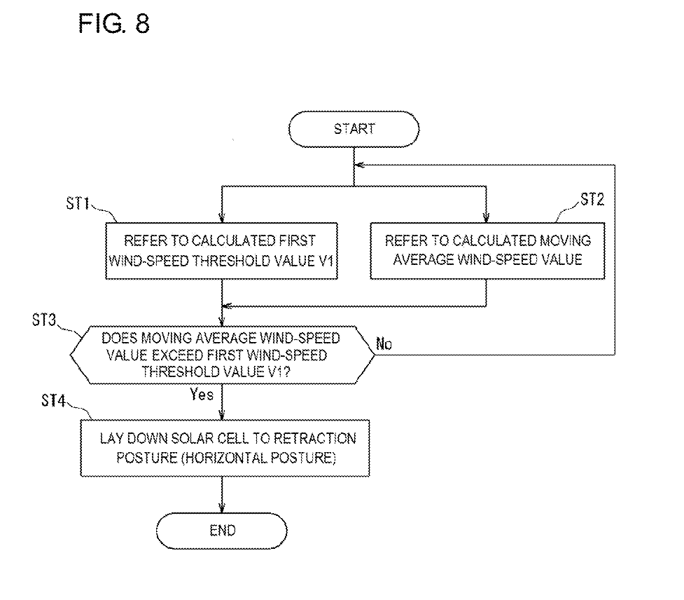

FIG. 8 is a flowchart of a retraction control executed by a solar tracking-type photovoltaic power generation system control device according to a second embodiment of the present invention. Steps ST1 to ST3 of the retraction control in the present embodiment are the same as those in the first embodiment. Therefore, a description of the steps ST1 to ST3 is omitted.

In the step ST3, in the case where the moving average wind-speed value exceeds the first wind-speed threshold value V1, the control part 14 lays down the solar cell 2 to a retraction posture by the driving means 3 (step ST4). In this case, the control part 14 lays down the solar cell 2 so that the array angle θ of the solar cell 2 becomes 0°, that is, to lay down to the horizontal posture (the position shown by the solid line in FIG. 2B) in which the light-receiving surface 2b of the solar cell 2 is positioned horizontally.

As described above, according to the control device 4 of the solar tracking-type photovoltaic power generation system 1 of the present embodiment, the retraction posture formed by laying down the solar cell 2 in the retraction control is the horizontal posture in which the light-receiving surface 2b of the solar cell 2 is positioned horizontally. Accordingly, by the retraction control, the solar cell 2 can be positioned in the safest retraction posture in which the solar cell 2 can withstand strong winds.

The retraction posture in the present embodiment is the horizontal posture (array angle θ of solar cell 2=0°). Alternatively, the solar cell 2 may be slightly tilted with respect to the horizontal plane H. In such a case, the array angle θ of solar cell 2 is preferably set to a range of more than 0 and 20° or less.

### OTHER MODIFICATIONS

It is to be understood that the embodiments disclosed herein are only illustrative and are not restrictive in all respects. The scope of the present invention is not the meaning described above but is defined by the claims. It is intended that the scope of the present invention includes meaning equivalent to the claims and all modifications within the scope of the claims.

For example, FIG. 6 shows an example in which the solar cell is laid down to the horizontal posture in two stages. Alternatively, the solar cell may be laid down more finely in multiple stages of three or more stages. Furthermore, regarding the combination of the retraction control in which a solar cell is subjected to a retraction operation in this manner and the revertive control in which a solar cell is subjected to a revertive operation shown in FIG. 7, an optimal flowchart can be set in accordance with wind conditions in the place where the solar cell is installed.

That is, the present invention is not limited to the embodiments described above and can be carried out by a suitable change as long as the present invention achieves an advantage that the time during which a solar cell is positioned in an inclination posture, in which the solar cell can generate electric power, can be extended while ensuring measures against strong winds.

1. A solar tracking-type photovoltaic power generation system control device including a solar cell and driving means that inclines and rotates the solar cell so that a light-receiving surface of the solar cell tracks the sun, the control device comprising:
posture detecting means that detects an inclination posture of the solar cell;
wind-speed measurement means that measures a wind speed;
a setting part that sets a first wind-speed threshold value each time in accordance with the inclination posture of the solar cell detected by the posture detecting means; and
a control part that performs a retraction control in which, in a case where a wind speed value measured by the wind-speed measurement means exceeds the first wind-speed threshold value, the solar cell is laid down by the driving means and is positioned in a retraction posture.

2. The solar tracking-type photovoltaic power generation system control device according to claim 1, wherein the control part performs a revertive control in which, in a case where, after the retraction control is performed, the wind speed value measured by the wind-speed measurement means is lower than a second wind-speed threshold value for a predetermined period of time, the solar cell is caused to revert to an inclination posture in which solar cell tracks the sun.

3. The solar tracking-type photovoltaic power generation system control device according to claim 1, wherein the retraction posture is a posture in which the light-receiving surface of the solar cell is positioned horizontally.

4. The solar tracking-type photovoltaic power generation system control device according to claim 1, wherein the retraction posture is a posture in which the light-receiving surface of the solar cell is tilted in a rising direction with respect to a horizontal plane.

5. The solar tracking-type photovoltaic power generation system control device according to claim 4, wherein, in the retraction control, in a case where the wind speed value measured by the wind-speed measurement means exceeds a third wind-speed threshold value after the solar cell is positioned in the retraction posture, the control part further lays down the solar cell by the driving means until the light-receiving surface of the solar cell is positioned horizontally.

6. The solar tracking-type photovoltaic power generation system control device according to claim 1, wherein the solar cell is a concentrating solar cell that generates electric power by concentrating sunlight.

7. A solar tracking-type photovoltaic power generation system comprising:
a solar cell;
driving means that inclines and rotates the solar cell so that a light-receiving surface of the solar cell tracks the sun; and
the solar tracking-type photovoltaic power generation system control device according to claim 1.

8. The solar tracking-type photovoltaic power generation system according to claim 7, comprising:
a plurality of solar tracking-type photovoltaic power generation devices each including the solar cell and the driving means that form a pair,
wherein the control device includes the posture detecting means that is single posture detecting means, the wind-speed measurement means that is single wind-speed measurement means, the setting part that is a single setting part, and the control part that is a single control part, and
the single control part performs the retraction control for the solar cells of the solar tracking-type photovoltaic power generation devices of the pairs.
